(19) United States
(12) Patent Application Publication
(10) Pub. No.: US 2024/0393457 A1
(43) Pub. Date: Nov. 28, 2024

(54) ON-VEHICLE RADAR DEVICE

(71) Applicant: TOYOTA JIDOSHA KABUSHIKI KAISHA, Toyota-shi (JP)

(72) Inventor: Kento TAKAOKA, Toyota-shi (JP)

(73) Assignee: TOYOTA JIDOSHA KABUSHIKI KAISHA, Toyota-shi (JP)

(21) Appl. No.: 18/662,497

(22) Filed: May 13, 2024

(30) Foreign Application Priority Data
May 24, 2023 (JP) 2023-085255

(51) Int. Cl. G01S 13/931; G01S 13/52

(52) U.S. Cl. CPC G01S 13/931; G01S 13/52; G01S 2013/932

(57) ABSTRACT

The on-vehicle radar device 1 can acquire sets of stationary reflection point information SI, which consist of information related to each reflection point that is stationary in the vicinity of the own vehicle, based on the physical quantities of radio waves emitted and received by the transceiver. If the similarity SIM between the first set of stationary reflection point information acquired at the first point in time before the ignition switch transitions from the ON to the OFF state after the vehicle has stopped, and the second set of stationary reflection point information acquired at the second point in time after the ignition switch has transitioned back to the ON state before the vehicle starts moving, is below the threshold SIMth, then the device does not provide the solid object information to other devices until certain conditions are met after the vehicle has started moving.

### BACKGROUND OF THE INVENTION

The present invention relates to an on-vehicle radar device that acquires information about solid objects existing around the own vehicle.

### DESCRIPTION OF THE RELATED ART

An on-vehicle radar device has been proposed (see, for example, Patent Document 1 below) that acquires information about solid objects existing around the own vehicle. This on-vehicle radar device (hereinafter referred to as “conventional device”) is equipped with a transceiver and a processor. The transceiver emits radio waves (millimeter-wave band radio waves) in a predetermined area centered around a radar beam axis extending in a specified direction from the own vehicle and receives radio waves reflected by solid objects located within the predetermined area. The processor acquires solid object information such as the position and speed of the solid objects relative to the own vehicle based on physical quantities related to the emitted and received radio waves (reflected waves). This solid object information is provided, for example, to a driving assistance device. The driving assistance device performs various driving assistance controls (such as Adaptive Cruise Control (ACC), Lane Tracing Assistant (LTA)) based on the solid object information.

Furthermore, the processor, while the own vehicle is moving straight, acquires the direction (angle θ between a straight line passing through one end of the radar beam axis (the end point on the side of the own vehicle) and the reflection point and the radar beam axis), the distance d between one end of the radar beam axis and the stationary reflection point, and the relative speed Vs (rate of change of distance d) of the reflection points that are stationary in the vicinity of the own vehicle. Based on the speed Vh of the own vehicle, the angle θ, and the relative speed Vs, the processor calculates the actual deviation of the radar beam axis from the design-normal radar beam axis (hereinafter referred to as “axis deviation”). The processor corrects the solid object information based on the acquired axis deviation and provides the corrected solid object information to the driving assistance device.
Patent Document 1: Japanese Unexamined Patent Application Publication No. 2002-228749

### SUMMARY

The conventional device detects the axis deviation based on the speed Vh, angle θ, and relative speed Vs. Therefore, when the own vehicle is stationary (such as when parked), it is not possible to acquire the axis deviation. There is a possibility that the radar beam axis might be displaced (either an increase or decrease in axis deviation) due to some factor while the own vehicle is stationary. The processor of the conventional device cannot update the axis deviation until the own vehicle starts moving straight after it has started. Even if the radar beam axis is displaced during the period when the own vehicle is parked, immediately after the own vehicle has started, the displacement of the radar beam axis is not reflected in the axis deviation. In this case, there is a possibility that the accuracy of the axis deviation is low, leading to low accuracy of the solid object information. When such inaccurate solid object information is provided from the conventional device to the driving assistance device and driving assistance is executed based on this information, there is a risk of reducing the safety of the own vehicle.

One object of the present invention is to provide an on-vehicle radar device that can suppress the provision of inaccurate solid object information to other devices.

To solve the above problem, the on-vehicle radar device (1) of the present invention comprises:
a transceiver (10) that emits radio waves in a predetermined area (A) centered on a radar beam axis (AX) extending in a specified direction from the own vehicle and receives radio waves reflected by solid objects located in the predetermined area, and
a processor (20) that acquires solid object information related to the solid objects located in the predetermined area based on physical quantities related to the emitted and received radio waves.

The processor is capable of acquiring a set of stationary reflection point information (SI) consisting of information related to each reflection point (SP) that is stationary in the vicinity of the own vehicle based on the physical quantities,
and is configured not to provide the solid object information to other devices until a predetermined condition is met if the similarity (SIM) between the first stationary reflection point information set (SIS1) and the second stationary reflection point information set (SIS2) is below a threshold (SIMth), wherein the first stationary reflection point information set is obtained at a first point in time before the ignition switch transitions from ON to OFF after the own vehicle has stopped, and the second stationary reflection point information set is obtained at a second point in time after the ignition switch has transitioned back from OFF to ON, before the own vehicle starts moving.

The processor of the on-vehicle radar device according to the present invention acquires the similarity of the first stationary reflection point information set obtained before the ignition switch transitions to the OFF state and the second stationary reflection point information set obtained after the ignition switch transitions to the ON state. If this similarity is relatively low (below the threshold), it is highly likely that the radar beam axis has been displaced during parking. In this case, the processor does not provide the solid object information to other devices (such as a driving assistance device) until certain conditions (conditions for determining that accurate solid object information has been obtained) are met. Thus, according to the present invention, it is possible to suppress the provision of inaccurate solid object information to other devices.

In one embodiment of the on-vehicle radar device according to the present invention, the processor acquires the deviation amount of the actual position and posture of the radar beam axis from the design-normal position and posture relative to the body of the own vehicle at a time point before the first point in time, and if the similarity exceeds the threshold, corrects the solid object information based on the deviation amount and provides the corrected solid object information to other devices at the point when the own vehicle starts moving.

If the similarity is relatively high (exceeding the threshold), it is highly likely that the radar beam axis has not been displaced during parking. That is, the deviation amount acquired before parking and the deviation amount at the point when the own vehicle starts moving are equivalent. Therefore, the processor corrects the solid object information based on the deviation amount acquired before parking and provides the corrected solid object information to other devices at the point when the own vehicle starts moving. In this case, accurate solid object information is provided to other devices at the point when the own vehicle starts moving.

In one embodiment of the on-vehicle radar device according to the present invention, the processor acquires the deviation amount based on information related to the behavior of the own vehicle and information related to the reflection points while the own vehicle is running.

As is well known, it is possible to acquire the deviation amount while the own vehicle is stopped using a specific calibration device, but this operation is complicated. According to this embodiment, the deviation amount is automatically acquired while the own vehicle is running, eliminating the need for such complicated operations.

In one embodiment of the on-vehicle radar device according to the present invention, the processor, when the similarity is below the threshold, controls a notification device equipped in the own vehicle to present information indicating that the radar beam axis has been displaced to the driver.

Accordingly, it is possible to prompt the driver or a repair technician to correct the mounting position and posture of the transceiver or to manually acquire the deviation amount (for example, by using a designated calibration device).

In another embodiment of the on-vehicle radar device according to the present invention, the physical quantities include the strength of the radio waves received by the transceiver.

The reflectivity of radio waves is correlated with the material composing the surface of the solid object. According to the present invention, it is possible to detect information about solid objects (such as the type of solid objects and the boundaries of adjacent solid objects) more accurately based on the strength of the reflected waves.

### BRIEF DESCRIPTION OF THE DRAWINGS

FIG. 1 is a block diagram of an on-vehicle radar device according to one embodiment of the present invention.

FIG. 2A is a plan view showing a first example of a method for acquiring the deviation amount while the own vehicle is moving straight.

FIG. 2B is a plan view showing a second example of a method for acquiring the deviation amount while the own vehicle is moving straight.

FIG. 3 is a flowchart of a program for acquiring the deviation amount while the own vehicle is moving straight.

FIG. 4 is a flowchart of a program for acquiring stationary reflection point information sets when the own vehicle has stopped.

FIG. 5 is a flowchart of a program for detecting whether the radar beam axis has been displaced during parking.

FIG. 6 is a flowchart of a program for deciding whether to provide solid object information to other devices.

### DESCRIPTION OF THE EMBODIMENTS

### Overview

An on-vehicle radar device 1 according to one embodiment of the present invention is installed in a vehicle V1 (own vehicle) equipped with an autonomous driving function. The on-vehicle radar device 1 acquires information about solid objects OB located in a predetermined area A centered around a predetermined radar beam axis AX extending in front of the own vehicle (solid object information). The solid object information is provided to other devices installed in the own vehicle. For example, the solid object information is provided to the ECU of a driving assistance device, and the ECU can perform various driving assistance based on the solid object information. The on-vehicle radar device 1 also has a function (axis deviation correction function) to acquire the actual position and posture deviation amount (hereinafter referred to as “axis deviation ΔAX”) of the radar beam axis AX from the reference axis BA (design-normal position and posture of the radar beam axis AX) and corrects the solid object information based on the axis deviation ΔAX.

### Specific Configuration

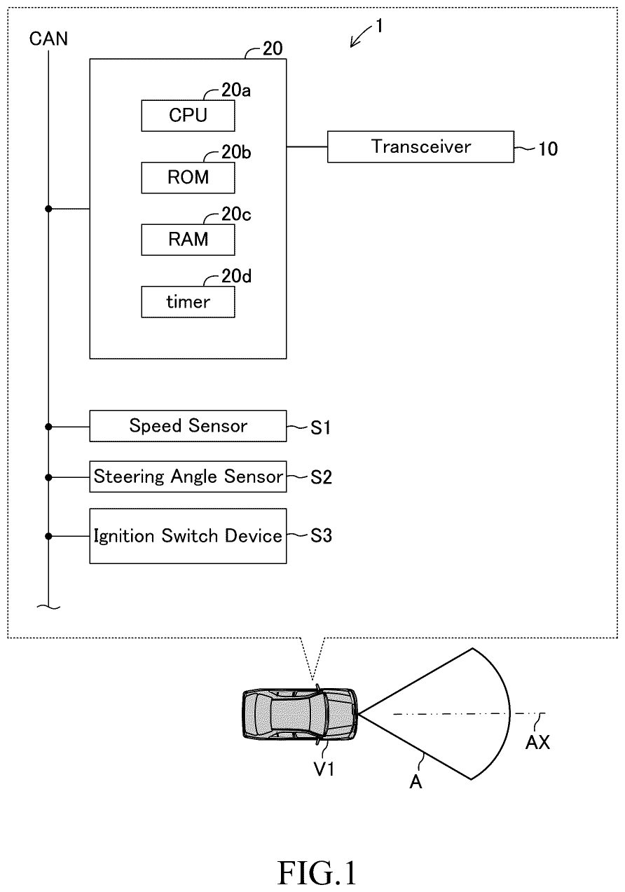

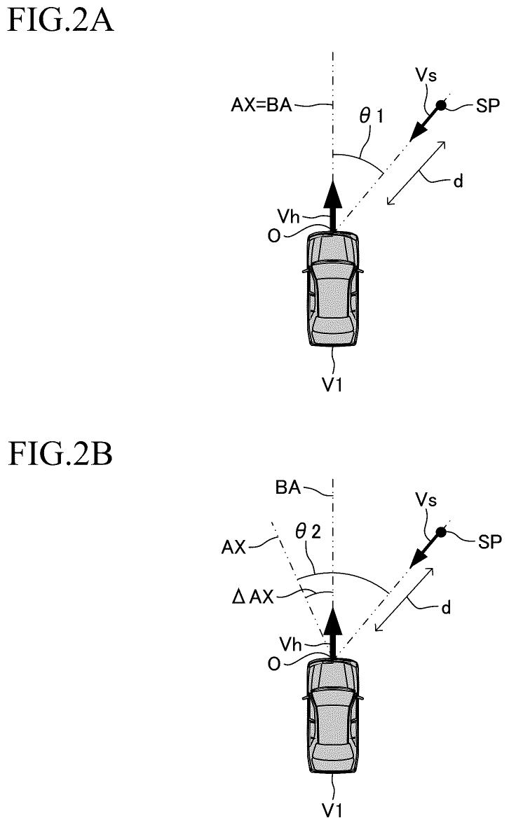

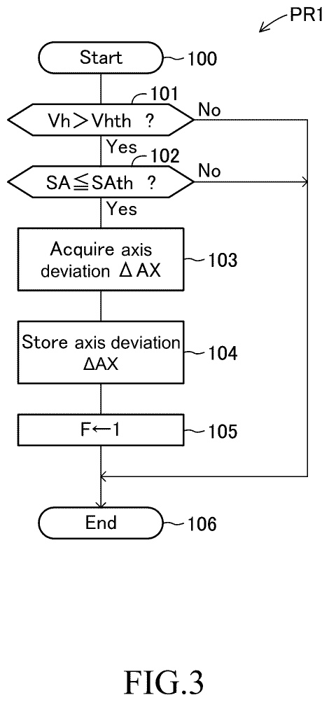

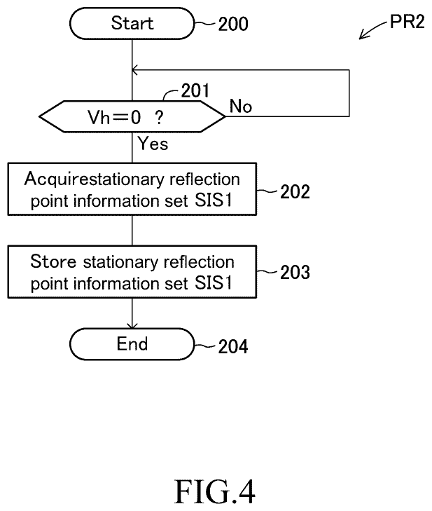

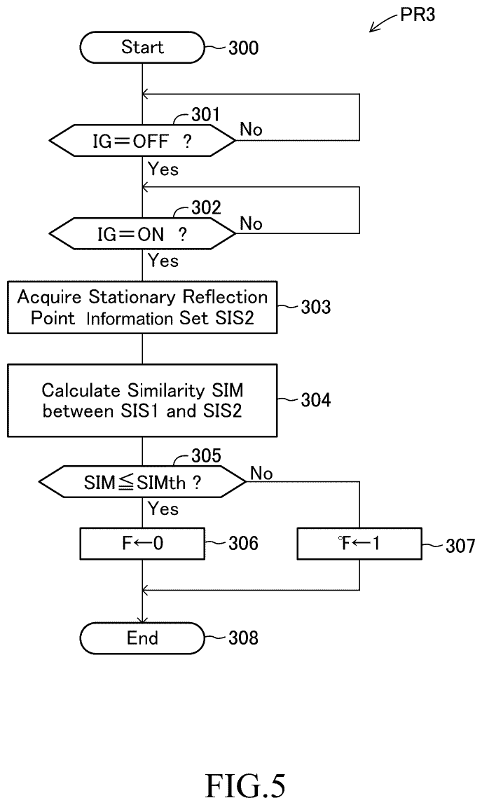

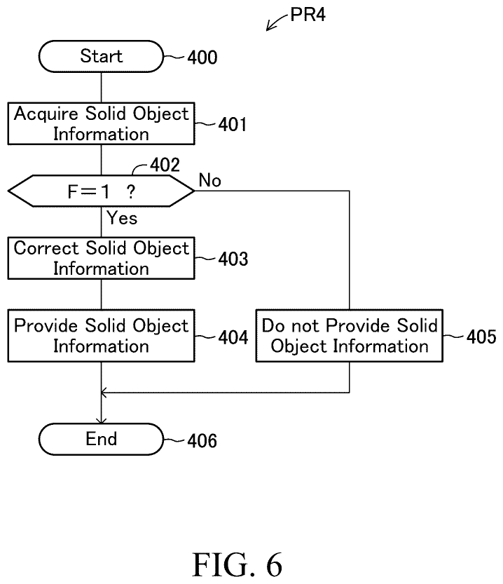

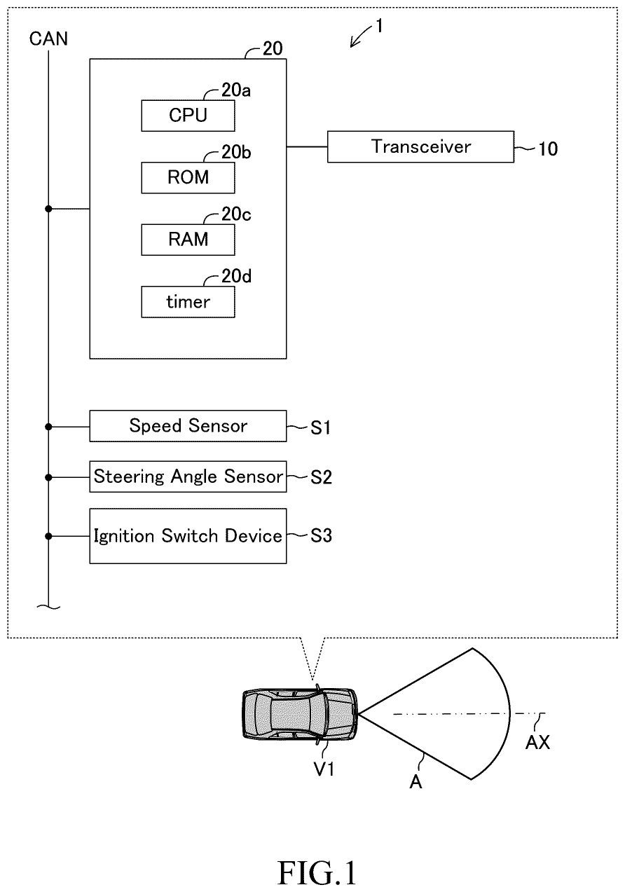

As shown in FIG. 1, the on-vehicle radar device 1 includes a transceiver 10 and a signal processing device 20.

The transceiver 10 includes a synthesizer, a transmission antenna, and a receiving antenna. The synthesizer generates and outputs a modulated wave signal. The transmission antenna and the receiving antenna are located at the center front of the own vehicle (for example, behind the emblem). The transmission antenna radiates the modulated wave signal output from the synthesizer as radio waves into a substantially conical area A extending in front of the own vehicle. The receiving antenna receives the radio waves (reflected waves) reflected by solid objects located within area A. The receiving antenna provides the signal processing device 20 with signals representing the received reflected waves.

Additionally, the frequency of the radio waves belongs to the millimeter wave band. In the following description, the central axis within area A is referred to as “radar beam axis AX”. At the production factory of the own vehicle, the apex of area A (one end of the radar beam axis AX) coincides with the central front of the own vehicle (hereinafter referred to as “origin O”), and is installed on the vehicle so that it is parallel (horizontal) to the front-rear direction of the vehicle (i.e., matching the design-normal position and posture). Due to vibrations and shocks that occur while the vehicle is in transit after leaving the production factory, the actual position and posture deviation of the radar beam axis AX from the design position and posture (reference axis BA) can fluctuate.

The signal processing device 20 includes a microcomputer equipped with a CPU 20a, ROM 20b (flash ROM), RAM 20c, and a timer 20d. The signal processing device 20 is connected via a communication line (or bus), such as CAN, to other ECUs in the own vehicle (for example, ECUs that perform driving assistance like ACC, LTA, hereinafter referred to as “driving assistance ECU”).

Furthermore, the signal processing device 20 is connected via the communication line to a speed sensor S1 and a steering angle sensor S2. The signal processing device 20 acquires the speed Vh of the own vehicle and the steering angle SA from the speed sensor S1 and the steering angle sensor S2, respectively. Additionally, the signal processing device 20 is connected via the communication line to the ignition switch device S3. The signal processing device 20 acquires the ON/OFF status of the ignition switch from the ignition switch device S3. The speed Vh, steering angle SA, and the ON/OFF status of the ignition switch can also be acquired from the driving assistance ECU.

### Operation

The signal processing device 20 acquires reflection point information (PI) for each reflection point P based on the physical quantities related to radio waves, which include the time from when the transceiver 10 emits the radio waves (transmission waves) to when it receives the reflected waves, the phase difference between the transmitted and reflected waves, the strength (attenuation level) of the reflected waves, the wavelength of the reflected waves, and the frequency spectrum of the composite wave of the transmitted and reflected waves. Each reflection point information PI comprises three-dimensional information including the angle θ between a straight line passing through one end of the radar beam axis AX and the reflection point P and the radar beam axis AX, the distance d between one end of the radar beam axis AX and reflection point P, and the relative speed Vs (rate of change of distance d).

The signal processing device 20 acquires a set of reflection point information (PIS) consisting of multiple pieces of reflection point information PI corresponding to each reflection point P when the ignition switch of the own vehicle is in the ON state. Based on the reflection point information set PIS, the signal processing device 20 sequentially acquires solid object information about the solid objects located around the own vehicle, such as the type, position, and speed of the solid objects. Furthermore, as described below, while the own vehicle is running, the signal processing device 20 sequentially acquires the axis deviation ΔAX and corrects the solid object information based on the axis deviation ΔAX. The signal processing device 20 then provides the corrected solid object information to other devices, such as the driving assistance ECU.

Next, the axis deviation correction function of the on-vehicle radar device 1 is described. Similar to the device in Patent Literature 1, the on-vehicle radar device 1 sequentially acquires (updates) the axis deviation ΔAX while the own vehicle is running. Specifically, when the ignition switch of the own vehicle is in the ON state, the signal processing device 20 acquires the speed Vh and steering angle SA at a predetermined interval from the speed sensor S1 and the steering angle sensor S2. If the speed Vh exceeds the threshold Vhth and the steering angle SA is below the threshold SAth, the signal processing device 20 determines that the own vehicle is moving straight. In this case, the signal processing device 20 identifies a stationary reflection point P (hereinafter referred to as “stationary reflection point SP”) based on the reflection point information set PIS. Then, as described below, the signal processing device 20 calculates the axis deviation ΔAX based on the direction of each stationary reflection point SP (the angle θ between a straight line passing through one end of the radar beam axis AX and the stationary reflection point SP and the radar beam axis AX) and the relative speed Vs (rate of change of distance d between one end of the radar beam axis AX and the stationary reflection point SP).

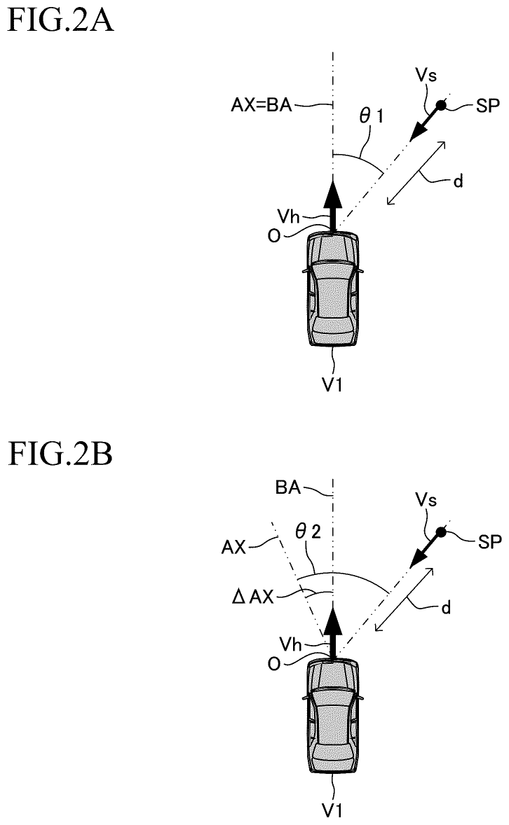

For example, the signal processing device 20 obtains the axis deviation ΔAX (angular deviation in a plan view) as follows. FIG. 2A shows a situation where a stationary reflection point SP is located diagonally right in front of the own vehicle and the radar beam axis AX aligns with the reference axis BA. In this example, the following equation (1) holds:

$$Vs = Vh \times cos θ 1 \qquad ( 1 )$$

On the other hand, FIG. 2B shows a situation where the stationary reflection point SP is at the same location as in FIG. 2A, but the radar beam axis AX is tilted to the left front. As shown in the figure, even if the radar beam axis AX deviates from the reference axis BA, the relative speed Vs obtained based on the physical quantities of the radio waves remains the same as when the radar beam axis AX aligns with the reference axis BA (FIG. 2(A)). That is, in the example shown in FIG. 2(B), angle θ2 is larger than angle θ1, but the relative speed Vs remains the same as in the example shown in FIG. 2A. Therefore, the following equation (2) holds:

$$Vh \times cos ( θ2 - Δ AX ) = Vs \qquad ( 2 )$$

Based on equation (2), the axis deviation ΔAX can be obtained (see equation (3) below):

$$Δ AX = θ2 - ArcCos ( Vs / Vh ) \qquad ( 3 )$$

In the examples shown in FIGS. 2A and 2B, one end of the radar beam axis AX coincides with the origin O. The signal processing device 20 can acquire the deviation of the radar beam axis AX from the origin O using the same method as the conventional devices. Additionally, the signal processing device 20 may also acquire the axis deviation ΔAX using the method disclosed in Japanese Patent Application Laid-open No. 2018-54315.

Next, a function for detecting whether the radar beam axis AX has been displaced during the period when the own vehicle is stationary (while parked) is described. When the signal processing device 20 detects that the speed Vh is “0”, it stores the latest axis deviation ΔAX acquired before the first point in time (writing into ROM 10b). Furthermore, at the first point in time, the signal processing device 20 acquires information about multiple stationary reflection points SP that are further than a threshold distance dth (for example, 50 centimeters) from the own vehicle (hereinafter referred to as “stationary reflection point information SI”). The signal processing device 20 then stores these stationary reflection point information SI as a set of stationary reflection point information SIS1.

Subsequently, when the signal processing device 20 detects that the ignition switch of the own vehicle has transitioned to the OFF state and then back to the ON state, at the second point in time, it acquires a set of stationary reflection point information SIS2 consisting of stationary reflection point information SI from multiple stationary reflection points SP that are further than the threshold distance dth (for example, 50 centimeters) from the own vehicle.

The signal processing device 20 calculates the similarity (SIM) between the stationary reflection point information set SIS1 and the stationary reflection point information set SIS2. Specifically, the signal processing device 20 computes the cosine similarity for all combinations of stationary reflection point information SI that make up SIS1 and each stationary reflection point information SI that makes up SIS2, and acquires the sum of these cosine similarities as the similarity SIM. If the similarity SIM is below the threshold SIMth, the signal processing device 20 determines that the radar beam axis AX has been displaced (the axis deviation ΔAX has changed) during the time between the first and the second point (while parked). In this case, the signal processing device 20 will not provide the solid object information to the driving assistance device until the third point in time, when the vehicle is driving straight and the axis deviation ΔAX can be updated. Therefore, driving assistance is prohibited during this period (from the second to the third point in time). Conversely, if the similarity SIM exceeds the threshold SIMth, the signal processing device 20 determines that the radar beam axis AX has not been displaced (the axis deviation ΔAX has not changed) during the time between the first and second points (while parked). In this case, the signal processing device 20 acquires the solid object information at the second point in time and corrects it based on the stored axis deviation ΔAX. The signal processing device 20 then provides the corrected solid object information to the driving assistance device. Thus, driving assistance is executed immediately after the ignition switch transitions to the ON state (at the second point). The threshold SIMth corresponds to the minimum value of the similarity SIM that allows safe execution of driving assistance, and this lower limit is determined experimentally.

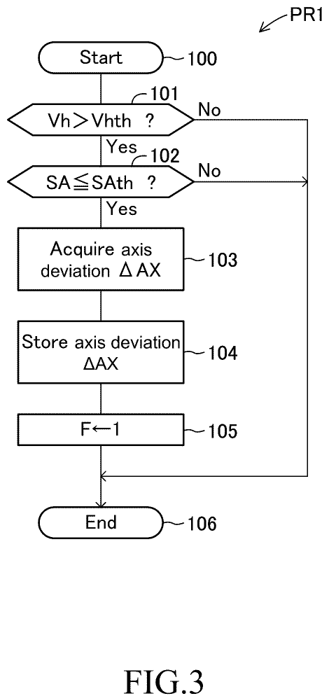

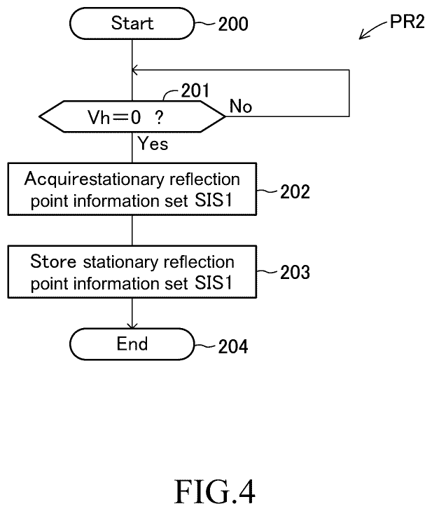

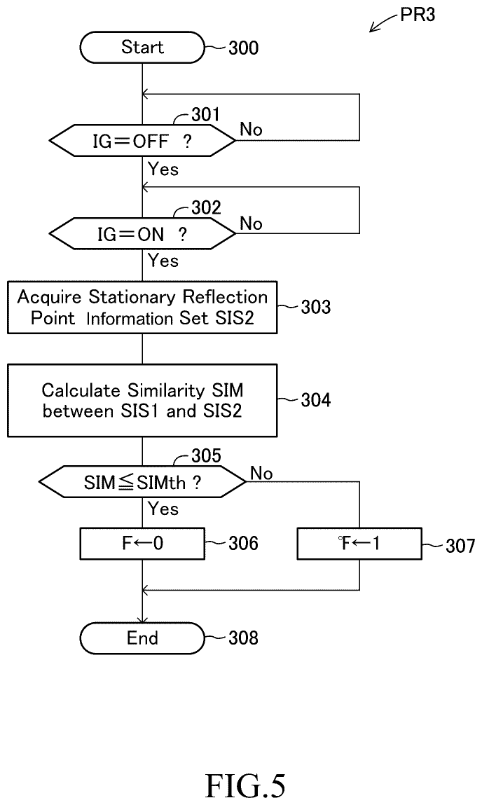

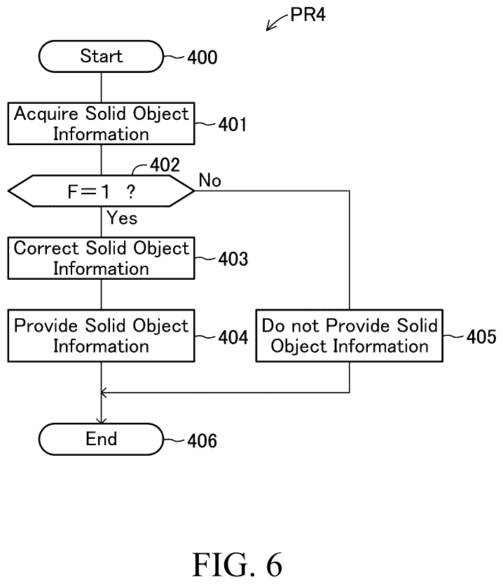

Next, referring to FIGS. 3 to 6, the programs PR1 to PR4 executed by the CPU 20a (hereinafter simply referred to as “CPU”) to implement the aforementioned driving support functions are described. The CPU executes each program in parallel. When execution of each program is completed, the CPU starts executing each program again. In these programs, a flag F is used. The flag F indicates whether the solid object information can be provided to the driving assistance device. If flag F is “0”, the CPU cannot provide the solid object information to the driving assistance device. If flag F is “1”, the CPU can provide the solid object information to the driving assistance device. When the own vehicle is shipped from the factory, flag F is set to “1”.

### Program PR1

The CPU starts executing program PR1 from step 100 and proceeds to step 101.

At step 101, the CPU determines whether the speed Vh exceeds the threshold Vhth. If the speed Vh exceeds the threshold Vhth (101: Yes), the CPU proceeds to step 102. Conversely, if the speed Vh does not exceed the threshold Vhth (101: No), the CPU proceeds to step 106 and ends the execution of program PR1.

At step 102, the CPU determines whether the steering angle SA is below the threshold SAth. If the steering angle SA is below the threshold SAth (indicating that the own vehicle is moving straight) (102: Yes), the CPU proceeds to step 103. Conversely, if the steering angle SA is not below the threshold SAth (102: No), the CPU proceeds to step 106 and ends the execution of program PR1.

At step 103, the CPU acquires the axis deviation ΔAX. Then, the CPU proceeds to step 104.

At step 104, the CPU stores the axis deviation ΔAX in ROM 20b. Then, the CPU proceeds to step 105.

The CPU sets flag F to “1” at step 105. Then, the CPU proceeds to step 106 and concludes the execution of program PR1. If flag F was already “1” when starting step 105, the CPU maintains flag F at “1” and moves to step 106.

### Program PR2

The CPU begins executing program PR2 from step 200 and moves to step 201.

At step 201, the CPU determines whether the speed Vh of the own vehicle is “0”. If the CPU determines that the speed Vh is “0” (i.e., the own vehicle is stopped) (201: Yes), it proceeds to step 202. Conversely, if the CPU determines that the speed Vh is not “0” (201: No), it returns to step 201.

At step 202, the CPU acquires the stationary reflection point information set SIS1. Then, the CPU proceeds to step 203.

At step 203, the CPU stores the stationary reflection point information set SIS1 in ROM 10b. Thus, when the CPU detects that the vehicle has stopped, it acquires the stationary reflection point information set SIS1 and stores it in ROM 10b before the ignition switch transitions to the OFF state. Next, the CPU proceeds to step 204 and concludes the execution of program PR2.

### Program PR3

The CPU starts executing program PR3 from step 300 and moves to step 301.

At step 301, the CPU determines whether the ignition switch of the own vehicle is in the OFF state. If the CPU determines that the ignition switch is in the OFF state (301: Yes), it proceeds to step 302. Conversely, if the CPU determines that the ignition switch is not in the OFF state (301: No), it returns to step 301.

At step 302, the CPU determines whether the ignition switch is in the ON state. If the CPU determines that the ignition switch is in the ON state (302: Yes), it proceeds to step 303. Conversely, if the CPU determines that the ignition switch is not in the ON state (302: No), it returns to step 302.

At step 303, the CPU acquires the stationary reflection point information set SIS2. Then, the CPU proceeds to step 304.

At step 304, the CPU reads the stationary reflection point information set SIS1 from ROM 10b and calculates the similarity SIM between the stationary reflection point information set SIS1 and the stationary reflection point information set SIS2. Next, the CPU proceeds to step 305.

At step 305, the CPU determines whether the similarity SIM is below the threshold SIMth. If the CPU determines that the similarity SIM is below the threshold SIMth (indicating that the similarity is relatively low) (305: Yes), it proceeds to step 306. Conversely, if the CPU determines that the similarity SIM is not below the threshold SIMth (305: No), it proceeds to step 307.

The CPU sets flag F to “0” at step 306. Additionally, the CPU sets flag F to “1” at step 307. Then, the CPU moves on to step 308 and concludes the execution of program PR3.

### Program PR4

The CPU starts executing program PR4 from step 400 and proceeds to step 401.

At step 401, the CPU acquires solid object information based on the information (reflection point information set PIS) received from the transceiver 10. Then, the CPU moves to step 402.

At step 402, the CPU determines whether flag F is “1”. Note that flag F is set to “0” or “1” during the execution of programs PR1 and PR3. If the CPU determines that flag F is “1” (402: Yes), it proceeds to step 403. Conversely, if the CPU does not find flag F to be “1” (402: No), it moves to step 405.

At step 403, the CPU reads the axis deviation ΔAX from ROM 10b and corrects the solid object information based on this axis deviation ΔAX. Then, the CPU moves to step 404.

At step 404, the CPU provides the corrected solid object information to the driving assistance device. Then, the CPU proceeds to step 406 and concludes the execution of program PR4. Additionally, if the CPU moves from step 403 to step 405, it ends the execution of program PR4 without providing the solid object information to the driving assistance device by moving to step 406.

### Effects

The signal processing device 20 of the on-vehicle radar device 1 acquires the similarity SIM between the stationary reflection point information set SIS1 obtained before the ignition switch transitions to the OFF state and the stationary reflection point information set SIS2 obtained after the ignition switch transitions to the ON state. If this similarity SIM is relatively low (below the threshold SIMth), it is likely that the radar beam axis AX was displaced during parking. In this case, until certain conditions are met (the vehicle is driving straight and the axis deviation ΔAX is updated), the signal processing device 20 does not provide the solid object information to other devices (for example, the driving assistance device). Thus, according to this embodiment, it is possible to prevent the provision of inaccurate solid object information to other devices.

If the similarity SIM is relatively high (exceeding the threshold SIMth), it is likely that the radar beam axis AX has not been displaced during parking. That is, the axis deviation ΔAX acquired before parking and the axis deviation ΔAX at the point when the vehicle starts moving are equivalent. Therefore, the signal processing device 20 corrects the solid object information based on the axis deviation ΔAX obtained before parking, and provides the corrected solid object information to other devices when the vehicle starts moving. In this case, high-quality solid object information is provided to other devices at the moment the vehicle starts moving.

This invention is not limited to the embodiments described above and can be modified within the scope of the invention in various ways.

### Variation 1

In the described embodiment, the signal processing device 20 determines whether the own vehicle is moving straight based on information obtained from the steering angle sensor S2 when acquiring the axis deviation ΔAX. Alternatively (or additionally), the signal processing device 20 may determine whether the own vehicle is moving straight based on information obtained from other sensors such as acceleration sensors or yaw-rate sensors.

### Variation 2

The signal processing device 20 may notify the driver when it detects a high probability that the radar beam axis AX has been displaced during parking, based on the similarity SIM. In this case, the signal processing device 20, in principle, does not provide the solid object information to other devices. Later, when certain conditions are met, the signal processing device 20 may become able to provide solid object information to other devices. For example, this condition is met when the driver or a technician adjusts the position and orientation of the transceiver 10 such that the radar beam axis AX aligns with the reference axis BA and manually sets flag F to “1” using a designated device. Additionally, for example, the condition is met if the driver or a technician, while the vehicle is parked, uses a designated calibration device (a radio wave reflector placed at a specific location) to acquire the axis deviation ΔAX and manually sets flag F to “1” using the designated device.

### Variation 3

The signal processing device 20 may calculate the displacement amount ΔAXP of the radar beam axis AX that occurred during parking, based on the similarity SIM. Then, the signal processing device 20 may correct the solid object information by considering the displacement amount ΔAXP added to the axis deviation ΔAX obtained before parking, and provide the corrected solid object information to other devices when the own vehicle starts moving.

What is claimed is:

1. An on-vehicle radar device comprising:
a transceiver that emits radio waves in a predetermined area centered on a radar beam axis extending in a specified direction from the own vehicle and receives radio waves reflected by solid objects located in the predetermined area, and
a processor that acquires solid object information related to the solid objects located in the predetermined area based on physical quantities related to the emitted and received radio waves, wherein
the processor is capable of acquiring a set of stationary reflection point information consisting of information related to each reflection point that is stationary in the vicinity of the own vehicle based on the physical quantities,
and is configured not to provide the solid object information to other devices until a predetermined condition is met if the similarity between the first stationary reflection point information set and the second stationary reflection point information set is below a threshold, wherein the first stationary reflection point information set is obtained at a first point in time before the ignition switch transitions from ON to OFF after the own vehicle has stopped, and the second stationary reflection point information set is obtained at a second point in time after the ignition switch has transitioned back from OFF to ON, before the own vehicle starts moving.

2. An on-vehicle radar device according to claim 1, wherein
the processor acquires the deviation amount of the actual position and posture of the radar beam axis from the design-normal position and posture relative to the body of the own vehicle at a time point before the first point in time, and if the similarity exceeds the threshold, corrects the solid object information based on the deviation amount and provides the corrected solid object information to other devices at the point when the own vehicle starts moving.

3. An on-vehicle radar device according to claim 2, wherein
the processor acquires the deviation amount based on information related to the behavior of the own vehicle and information related to the reflection points while the own vehicle is running.

4. An on-vehicle radar device according to claim 1, wherein
the processor, when the similarity is below the threshold, controls a notification device equipped in the own vehicle to present information indicating that the radar beam axis has been displaced to the driver.

5. An on-vehicle radar device according to claim 1, wherein
the physical quantities include the strength of the radio waves received by the transceiver.
